(19) United States
(12) Patent Application Publication
(10) Pub. No.: US 2026/0357836 A1
(43) Pub. Date: Nov. 12, 2026

(54) Holding Element for a Motor Vehicle, and Motor Vehicle Comprising a Holding Element

(71) Applicant: Bayerische Motoren Werke Aktiengesellschaft, Muenchen (DE)

(72) Inventors: Heinrich GRAF, Eching (DE); Michael GUNKEL, Hoergertshausen (DE)

(21) Appl. No.: 19/515,097

(22) PCT Filed: Jul. 17, 2024
(86) PCT No.: PCT/EP2024/070280

§ 371 Date: Feb. 27, 2026

(30) Foreign Application Priority Data
Aug. 31, 2023 (DE) 10 2023 123 468.4

(51) Int. Cl. F16B 5/12; F16B 2/10

(52) U.S. Cl. CPC F16B 5/123; F16B 2/10; F16B 2200/95

(57) ABSTRACT

A holding element for a motor vehicle is designed to secure a first motor vehicle component to a second motor vehicle component. The holding element can be adjusted from a starting state into an installation state, in which the first motor vehicle component is connected to the second motor vehicle component. In the installation state, an electronically readable marking is released which cannot be electronically read in the starting state of the holding element.

### BACKGROUND AND SUMMARY

The invention relates to a holding element for a motor vehicle and a motor vehicle comprising a holding element.

DE 20 2017 104 318 U1 discloses a holding clamp which displays an installation for securing an insulating part to a substrate on a vehicle. The holding clamp comprises a pair of spaced-apart and opposing curved holding clamp arms, a flat foam part-holding element and a subassembly displaying the installation. This subassembly comprises a housing which is secured to the holding element and an axially movable elongated installation display with a substrate contact end, which extends between the arms, and a visually apparent display end.

Moreover, a mounting clip for securing lines to a motor vehicle underbody is also disclosed in EP 1 607 666B1 . The mounting clip comprises recesses for receiving lines and a through-opening for screwing the mounting clip to a securing means on the underbody of the motor vehicle.

Moreover, a method for the secure attachment of a sensor to a motor vehicle is disclosed in EP 2 060 447A1 . In a first step the sensor is attached to a motor vehicle and in a second step a marking structural element of the sensor is transferred from a first position into a second position which is visibly different from the first position. The second step can only be carried out when the first step has been correctly executed.

It is the object of the present invention to provide a solution which permits a particularly simple securing of a first motor vehicle component to a second motor vehicle component, whereby a correct installation can be reliably proved retrospectively.

This object is achieved according to the invention by the subjects of the independent claims. Further possible embodiments of the invention are disclosed in the dependent claims, the description and the figures. Features, advantages and possible embodiments which are set forth in the context of the description for one of the subjects of the independent claims are to be regarded at least analogously as features, advantages and possible embodiments of the respective subject of the other independent claims and any possible combination of the subjects of the independent claims, optionally in combination with one or more of the dependent claims.

The invention relates to a holding element for a motor vehicle, in particular an automobile, in particular a passenger motor vehicle. The holding element is designed to secure a first motor vehicle component to a second motor vehicle component. The holding element can be adjusted from a starting state into an installation state connecting the first motor vehicle component to the second motor vehicle component. In the installation state an electronically readable marking, which cannot be electronically read in the starting state of the holding element, is released. This means that the marking can only be electronically read when the holding element has been completely moved into the installation state and thus correctly connects the first motor vehicle component to the second motor vehicle component. If the holding element has not correctly connected the first motor vehicle component to the second motor vehicle component, then the holding element is not yet in the installation state. This means that the holding element is arranged in the installation state and, as a result, the marking can be electronically read only when the first motor vehicle component is connected correctly to the second motor vehicle component via the holding element. Since the marking was able to be read electronically, it can be retrospectively proved that the first motor vehicle component has been correctly mounted on the second motor vehicle component, for example via the electronically read marking being stored in a system. The holding element thus makes it possible to be able to prove in a reliable and dependable manner that the motor vehicle components have been correctly secured to one another by means of the holding element.

In one possible development of the invention, it is provided that the marking is a data matrix code. The data matrix code is a 2D code. A size of the generally square, sometimes also rectangular, code image can be determined from a large selection. Symbol elements in the code image can be square or round depending on the production method, which also applies to an edge pattern of the data matrix code. The data matrix code comprises four or five main components. As a first component, the data matrix code (DMC) comprises two pairs of solid continuous and interrupted edges as boundary lines, which can also be denoted as a finder pattern. Moreover, the DMC comprises a peripheral rest zone which is also denoted as a quiet zone. Moreover, the DMC also comprises a comer opposing the closed edges and an orientation pattern which is also denoted as an alignment pattern. Moreover, the DMC comprises a data area which comprises the actual binary information in coded form. The DMC can be read in a particularly simple manner by an electronic reading device, wherein the probability of errors when reading the DMC can be kept particularly low.

In a further possible embodiment of the invention, it is provided that the holding element has a journal element, wherein the installation state is produced when the journal element is inserted into an opening of the first motor vehicle component. Moreover, the holding element comprises a clamp with a first clamping element and a second clamping element, wherein the installation state is produced when the clamping elements additionally form a snap connection with one another, whereby the second motor vehicle component is clamped between the clamping elements.

Snap connections are functional elements for the releasable and umreleasable, simple positive joining of components. A joining part is resiliently deformed and is then releasably or unreleasably hooked to the other joining part. Thus a positive connection is present. In particular, one of the clamping elements comprises a latching hook which is hooked to the other of the clamping elements by forming the snap connection. In snap connections the resilience of the materials, generally plastics or spring steel, are utilized for the connection of two components, in the present case the clamping elements.

The installation state is thus produced only when the journal element is inserted into the opening of the first motor vehicle component and the clamping elements form the snap connection with one another. The journal element can have a plurality of peripheral obliquely positioned collars, the journal element being able to be hooked thereby in the opening. In particular, the installation state is only produced when the journal element is inserted at least to a predetermined insertion depth into the opening of the first motor vehicle component. For forming the snap connection, two latching elements of the clamping elements engage in one another. For example, one of the clamping elements can have a latching lug as a latching element and the other of the clamping elements can have a latching recess as a latching element. As soon as the latching lug is engaged in the latching recess, in particular by snapping in, the snap connection is produced between the clamping elements. The clamping elements can together enclose a region on the peripheral side in their interconnected state, wherein the second motor vehicle component is clamped in this enclosed region in the installation state. This means that the second motor vehicle component is fully encompassed on the peripheral side by the two clamping elements in some regions and thereby clamped. As a result, the second motor vehicle component is held particularly securely in the installation state on the holding element.

In a further possible embodiment of the invention, it is provided that the marking is arranged below a cover element, wherein the cover element is designed to be lifted in the installation state, whereby the marking can be electronically read. This means that in the starting state the marking is covered by means of the cover element such that the marking cannot be electronically read. By adjusting the holding element from the starting state into the installation state, the cover element is lifted, whereby access to the electrically readable marking is enabled for a reading device. As a result, the reading device can electronically read the marking. It is possible that by lifting the cover element in the installation state the cover element can be removed from a remainder of the holding element, whereby in the installation state the marking, which was covered in the starting state by means of the cover element, is no longer covered. The cover element can ensure in a particularly simple and reliable manner that the marking cannot be electronically read in the starting state, whereas the marking can be electronically read in the installation state.

In this context it can be provided, in particular, that the holding element comprises a connecting device which is designed to be adjusted between a neutral state, not lifting the cover element, and a lifted state, lifting the cover element in the installation state. The connecting device is designed to be adjusted from the neutral state into the lifted state by being supported on one of the motor vehicle components in the installation state. In particular, the connecting device transitions into the lifted state when the installation state of the holding element is adjusted. In particular, the connecting device is designed to transfer to the lifted state only when the holding element is arranged in the installation state. As a result, it is ensured that the cover element is lifted by means of the connecting device in order to enable the electronic reading of the marking only when the holding element is reliably arranged in the installation state.

In this context it can be provided, in particular, that the connecting device comprises a plurality of pin elements, one thereof being arranged in the first clamping element and a further one thereof being arranged in the second clamping element. In the installation state the pin elements are placed against one another in a force-transmitting manner, whereby the connecting device can lift the cover element by being supported on the motor vehicle component. The pin elements are not connected together in a force-transmitting manner when the holding element is not arranged in the installation state. As the pin elements are not connected together in a force-transmitting manner when the holding element is not arranged in the installation state, a transmission of force via the pin elements to the cover element is prevented, even when one of the pin elements is supported on one of the motor vehicle components, whereby in this case the cover element is prevented from being lifted by means of the connecting device. In other words, the cover element is lifted by means of the pin elements only when all of the pin elements of the connecting device are connected together in a force-transmitting manner and are supported on one of the motor vehicle components. This is the case only when the holding element is correctly arranged in the installation state.

In a further possible embodiment of the invention, it is provided that the cover element is a film. The film is adhesively bonded, in particular, over the marking. In the installation state, the cover element and thus the film are lifted, whereby an electronic reading device can read the marking below the film or whereby a person or a robot device can pull off the film, whereby the marking can be electronically read. In particular, it is only possible to pull off the film with a particularly high degree of effort, or not at all possible, if it has not been lifted in the installation state due to the correct mounting of the holding element.

In a further possible embodiment of the invention, it is provided that the holding element is designed to secure line elements to the first motor vehicle component. The line element can be, for example, a part of a hydrogen line or a part of a brake line. In particular, in the case of hydrogen lines or in brake lines it is important to ensure that they have been correctly mounted in the motor vehicle. The holding element thus makes it possible to establish retrospectively, using the electronically read marking, that the line has been initially correctly mounted.

The invention further relates to a motor vehicle comprising a holding element as has already been described in connection with the holding element according to the invention. The holding element is secured to a first motor vehicle component and a second motor vehicle component is in turn held on the holding element. As a result, the second motor vehicle component is held via the holding element on the first motor vehicle component. The installation state of the holding element is reached when the holding element is correctly secured to the first motor vehicle component and the second motor vehicle component is correctly secured to the holding element. This means that the installation state of the holding element is only reached when both motor vehicle components are securely held on the holding element and against one another via the holding element. As soon as the installation state of the holding element is reached, the marking of the holding element can be electronically read. The electronic reading of the marking can retrospectively prove that the holding element has been correctly mounted and thus the second motor vehicle component has been safely secured to the first motor vehicle component during installation.

In this context, it can be provided, in particular, that the holding element is arranged in the installation state when the journal element of the holding element is inserted as far as a predetermined end position in the opening of the first motor vehicle component and the clamping elements form the snap connection with one another, whereby the second motor vehicle component is encompassed by the clamping elements and clamped therebetween. In particular, the journal element of the holding element can be hooked into the opening of the first motor vehicle component in order to avoid a release of the holding element from the first motor vehicle component. The clamping elements are designed, in particular, to encompass and to clamp between one another a line element as a second motor vehicle component, whereby the line element can be held particularly securely on the first motor vehicle component via the holding element. The holding element permits a particularly simple and secure hold of the first motor vehicle component on the second motor vehicle component, whereby the electronically readable marking can particularly reliably prove whether the motor vehicle components have been correctly mounted.

Further features of the invention can be found in the claims, the figures and the description of the figures. The features and combinations of features mentioned above in the description and the features and combinations of features shown below in the description of the figures and/or shown individually in the figures are not only able to be used in the respectively specified combination but also in other combinations or individually without departing from the scope of the invention.

### BRIEF DESCRIPTION OF THE DRAWINGS

FIG. 1 is a schematic sectional view of a holding element for securing a first motor vehicle component to a second motor vehicle component;

FIG. 2 is a schematic sectional view of the holding element, wherein the holding element is not correctly secured to the first motor vehicle component and the second motor vehicle component is correctly secured to the holding element; and

FIG. 3 is a schematic sectional view of the holding element, wherein the holding element is arranged in an installation state in which the holding element is correctly secured to the first motor vehicle component and the second motor vehicle component is correctly held on the holding element.

Elements which are the same and functionally the same are provided with the same reference signs in the figures.

### DETAILED DESCRIPTION OF THE DRAWINGS

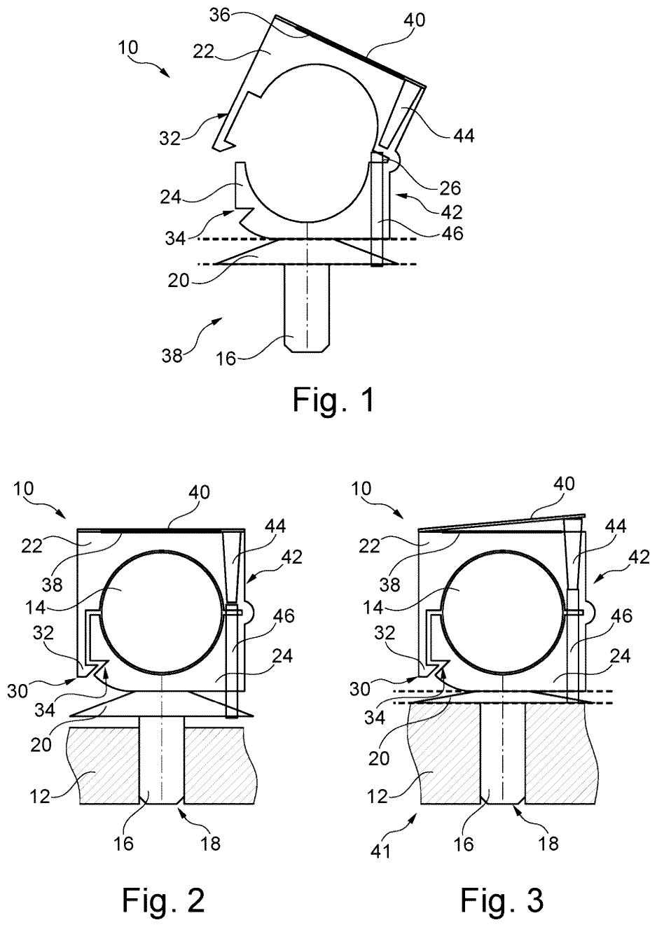

A holding element 10 for a motor vehicle is shown in FIG. 1. The holding element 10 is designed to secure a second motor vehicle component 14 to a first motor vehicle component 12. In the present case, the holding element 10 has a journal element 16 which is designed to be inserted into an opening 18 of the first motor vehicle component 12, as shown in FIGS. 2 and 3. The journal element 16 can be a fir tree-shaped journal element. In the present case, the holding element 10 also comprises a plate spring 20 which encloses the journal element 16 radially on the peripheral side. In the present case, the plate spring 20 protrudes as a collar from the journal element 16 on the peripheral side. A preloading of the holding element 10 on the first motor vehicle component 12 can be adjusted by means of the plate spring 20. In particular, it is provided that the journal element 16 is inserted into the opening 18 of the first motor vehicle component 12 as far as a predetermined end position, in order to ensure a secure hold of the holding element 10 on the first motor vehicle component 12. The holding element 10 is shown in FIGS. 2 and 3 in respective schematic sectional views, wherein the second motor vehicle component 14 is secured to the holding element 10 and the journal element 16 of the holding element 10 is inserted into the opening 18 of the first motor vehicle component 12.

In the state shown in FIG. 2, the journal element 16 is not inserted sufficiently deeply into the opening 18 of the first motor vehicle component 12.

In the state shown in FIG. 3, the journal element 16 is inserted into the opening 18 as far as the predetermined end position, whereby the plate spring 20 is brought to bear against the first motor vehicle component 12 and preloaded thereby. With correct installation of the holding element 10 on the first motor vehicle component 12, therefore, the plate spring 20 is placed against the first motor vehicle component 12, in particular in a surface region adjoining the opening 18, and subjected to preloading.

As can also be particularly clearly identified in FIG. 1, the holding element 10 also comprises two clamping elements 22, 24. The clamping elements 22, 24 are pivotable relative to one another about a pivot axis 26. In the present case, the pivot axis 26 runs perpendicularly to an insertion direction of the journal element 16 into the opening 18. When pivoting the clamping elements 22, 24 about the pivot axis 26, the clamping elements 22, 24 can be pivoted toward one another or away from one another. In particular, the clamping elements 22, 24 can be pivoted toward one another until the clamping elements 22, 24 together form a snap connection 30 as shown in FIG. 2 and FIG. 3. For producing this snap connection 30, a snap hook 32 of a first of the clamping elements 22 is resiliently deformed and snaps into a recess 34 of the second clamping element 24. If the snap connection 30 is produced, then the first clamping element 22 and the second clamping element 24 together form a positive connection, whereby the clamping elements 22, 24 are held securely against one another. The snap connection 30 is correctly produced when the snap hook 32 is at least substantially free of mechanical stresses. This means that for producing the snap connection 30 the snap hook 32 is resiliently deformed and then re-formed again resiliently, whereby the snap connection 30 is correctly produced. If the snap hook 32 is present in a deformation state which is resiliently deformed relative to an original state, then the snap connection 30 has not been correctly produced.

As can be identified in FIGS. 2 and 3, the clamping elements 22, 24 together encompass a region on the peripheral side in which the second motor vehicle component 14 can be received. In the present case, the second motor vehicle component 14 is a line element which is clamped between the clamping elements 22, 24 when it is arranged in the region enclosed by the clamping elements 22, 24. By clamping the line element between the clamping elements 22, 24, the line element is held securely on the holding element 10. Since the first clamping element 22 is fixedly held on the second clamping element 24 due to the snap connection 30, a risk of the snap connection 30 being released and, as a result, the second motor vehicle component 14 being released from the holding element 10 is particularly low.

As can be identified in FIGS. 2 and 3, the line element is radially encompassed, and in particular clamped, by the clamping elements 22, 24 over the entire periphery thereof. As a result, the line element is held particularly securely on the holding element 10. In order to be able to prove that the holding element 10 has been correctly secured to the first motor vehicle component 12 and the second motor vehicle component 14 has been correctly secured to the holding element 10, it is provided that the holding element 10 comprises an electronically readable marking 36, in the present case a data matrix code. This marking 36 is covered by a cover element 40 in a starting state 38 of the holding element 10 shown in FIG. 1, whereby in the starting state 38 the marking 36 cannot be read, in particular cannot be electronically read. The cover element 40 in the present case is a film. In FIG. 3, the holding element 10 is shown in an installation state 41 in which both the holding element 10 is correctly secured to the first motor vehicle component 12 and the second motor vehicle component 14 is correctly secured to the holding element 10. In the installation state 41 of the holding element 10 the cover element 40 is lifted, whereby the marking 36 can be electronically read. In particular, after it has been lifted, the cover element 40 can be removed, in particular pulled off, from a remainder of the holding element 10, whereby the marking 36 can be read electronically in a particularly simple manner. The marking 36 can be scanned, for example, so that as a result it is possible to store in an electronic storage device that the holding element 10 comprising this individual marking 36 has been correctly mounted.

A state of the holding element 10 is shown in FIG. 2 in which the second motor vehicle component 14 is correctly secured to the holding element 10, but the holding element 10 is not correctly secured to the first motor vehicle component 12. As a result, the cover element 40 is not lifted and the marking 36 also cannot be electronically read.

In the installation state 41 of the holding element 10, in order to enable the cover element 40 to be reliably lifted so that the marking 36 can be electronically read, it is provided that the holding element 10 comprises a connecting device 42. The connecting device 42 comprises a first pin element 44 and a second pin element 46. The first pin element 44 is held on the first clamping element 22. In the present case, the first pin element 44 extends through a channel in the first clamping element 22. The second pin element 46 is held on the second clamping element 24. In the present case, the second pin element 46 extends through a channel of the second clamping element 24.

As can be identified in FIGS. 1 and 3, in the installation state 41 the pin elements 44, 46 are placed against one another in a force-transmitting manner. The pin elements 44, 46 are not arranged in a force-transmitting manner relative to one another if the holding element 10 is not arranged in the installation state 41. By pivoting the clamping elements 22. 24 about the pivot axis 26 relative to one another and forming the snap connection 30, the pin elements 44, 46 are arranged one above the other in the insertion direction, in particular arranged parallel to one another with their respective longitudinal direction of extent and, in particular, parallel to the insertion direction. By inserting the journal element 16 into the opening 18, the second pin element 46 is brought to bear against the first motor vehicle component 12, whereby by inserting the journal element 16 as far as the predetermined end position, by the second pin element 46 being supported on the first motor vehicle component 12, the first pin element 44 is displaced within the channel of the first clamping element 22, as can be identified in FIG. 3, whereby the cover element 40 is lifted, in particular lifted off the marking 36, by means of the first pin element 44. The connecting device 42 can thus be adjusted from a neutral state in which the pin elements 44, 46 do not bear against one another, or at least do not bear against one another in a force-transmitting manner, into a lifted state lifting the cover element 40 in which a force transmission takes place from the second pin element 46 to the first pin element 44, whereby the cover element 40 is lifted. The connecting device 42 is adjusted into the lifted state by the adjustment of the holding element 10 into the installation state 41.

It is alternatively possible that the marking is directly attached to the first pin element 44. The pin element 44 can be flattened on its upper face or designed with a flag which has a machine readable code printed directly as a marking 36, whereby this marking 36 is released by the first pin element 44 emerging from the first clamping element 22.

The holding element 10 is a clip which, only after correct installation, releases the marking 36 as a scannable code which an operator can scan after a first installation step. As a result, it is possible to prove the correct first installation of the holding element 10. The holding element 10 is, in particular, a plastic clip. In particular, the holding element 10 is injection-molded from plastics. The data matrix code which is concealed by the cover element 40, which is configured as an opaque film, is located on the upper face of the holding element 10. When the clamping elements 22, 24 are correctly latched together and the journal element 16 is in the opening 18, a mechanical connection, which lifts the opaque film attached to the top of the holding element 10, is produced via the pin elements 44, 46. This film can only now be removed, after which the marking 36 becomes visible and scannable. This enables a simple checking and ability to document the correct installation of the holding element 10. The holding element 10 is correctly mounted only when the journal element 16 is inserted into the opening 18 of the first motor vehicle component 12 until it stops or until the plate of the plate spring 20 is overpressed. In the present case, the opening 18 can be formed by a bore in the first motor vehicle component 12. The second motor vehicle component 14 is, in particular, a hydrogen line or a high-voltage line or a brake line. If the clamping elements 22, 24 do not correctly form the snap connection 30 with one another, then a path which the second pin element 46 covers relative to the second clamping element 24 when the journal element 16 is correctly inserted in the opening 18, by being supported on the first motor vehicle component 12, is not sufficient in order to move the first pin element 44 sufficiently far relative to the first clamping element 22 such that the cover element 40 is lifted.

During initial assembly in the factory, the holding element 10 can be pre-mounted on the line or the cable as the second motor vehicle component 14 and the latching of the enclosure securely engaged and thus the snap connection 30 formed. It is possible to provide a plurality of parts of the marking 36 which can be configured in each case as a data matrix code and which can be made visible one after the other by means of separate connecting devices 42 for each of the two clipping processes. This means that a first part of the marking 36 becomes electronically readable as soon as the holding element 10 is correctly secured to the first motor vehicle component 12 and the second part of the marking 36 becomes electronically readable as soon as the holding element 10 is correctly secured to the second motor vehicle component 14.

Overall the invention shows how it is possible to prove the correct installation of holding clips, in the present case the holding element 10.

### LIST OF REFERENCE SIGNS

10 Holding element
12 First motor vehicle component
14 Second motor vehicle component
16 Journal element
18 Opening
20 Plate spring
22 First clamping element
24 Second clamping element
26 Pivot axis
30 Snap connection
32 Snap hook
34 Recess
36 Marking
38 Starting state
40 Cover element
41 Installation state
42 Connecting device
44 First pin element
46 Second pin element

1.-10. (Canceled)

11. A component for a motor vehicle, comprising:
a holding element configured to secure a first motor vehicle component to a second motor vehicle component,
wherein the holding element is adjustable from a starting state into an installation state, in which the first motor vehicle component is connected to the second motor vehicle component, and
wherein, in the installation state, an electronically readable marking, which cannot be electronically read in the starting state of the holding element, is released.

12. The component according to claim 11, wherein the electronically readable marking is a data matrix code.

13. The component according to claim 11, wherein
the holding element comprises a journal element,
the installation state is produced when the journal element is inserted into an opening of the first motor vehicle component, and
the holding element further comprises a clamp having a first clamping element and a second clamping element, and
the installation state is produced when the first and second clamping elements additionally form a snap connection with one another, whereby the second motor vehicle component is clamped between the first and second clamping elements.

14. The component according to claim 11, wherein
the electronically readable marking is arranged below a cover element, and
the cover element is configured to be lifted in the installation state, whereby the marking is then released and electronically readable.

15. The component according to claim 14, wherein
a connecting device is provided, which connecting device is configured to be adjusted between a neutral state, not lifting the cover element, and a lifted state, lifting the cover element in the installation state, and
the connecting device is further configured to be adjusted from the neutral state into the lifted state by being supported on one of the motor vehicle components in the installation state.

16. The component according to claim 15, wherein
the connecting device comprises a plurality of pin elements, one thereof being arranged in the first clamping element and a further one thereof being arranged in the second clamping element, and
in the installation state, the pin elements are placed against one another in a force-transmitting manner, whereby the connecting device can lift the cover element by being supported on the motor vehicle component,
wherein the pin elements are not connected together in a force-transmitting manner when the holding element is not arranged in the installation state.

17. The component according to claim 14, wherein the cover element is a film.

18. The component according to claim 11, wherein
the holding element is designed to secure a line element to the first motor vehicle component.

19. A motor vehicle, comprising:
a component according to claim 11; and
wherein the holding element is secured to the first motor vehicle component and the second motor vehicle component is held on the holding element, whereby the second motor vehicle component is held via the holding element on the first motor vehicle component.

20. The motor vehicle according to claim 19, wherein
the holding element is arranged in the installation state when a journal element of the holding element is inserted as far as a predetermined end position in an opening of the first motor vehicle component, and clamping elements of the holding element form a snap connection with one another, whereby the second motor vehicle component is encompassed by the clamping elements.
